(19) United States
(12) Patent Application Publication
(10) Pub. No.: US 2003/0021117 A1
(43) Pub. Date: Jan. 30, 2003

(54) High intensity light source capable of emitting various colored lights

(76) Inventor: Tsung-Wen Chan, Shijr City (TW)

Correspondence Address: BACON & THOMAS, PLLC, 4th Floor, 625 Slaters Lane, Alexandria, VA, 22314-1176, US

(21) Appl. No.: 09/915,280

(22) Filed: Jul. 27, 2001

(51) Int. Cl. F21V 9/16; F21K 2/00

(52) U.S. Cl. 362/260; 362/84; 362/231; 362/235; 362/293

(57) ABSTRACT

A high intensity light source has a LED assembly consisting of red, green and blue three primary colored LEDS enclosed in a globe whose inner wall surface is spray coated with a fluorescent powder for blending the emitted lights from the LEDS into various resultant colored lights by operating a control circuit, and the resultant lights are outputted through all directional refraction of the globe.

### BACKGROUND OF THE INVENTION

1. Field of the Invention

The present invention relates to a high intensity light source capable of emitting various colored lights, in particular, a light emitting diode (LED) assembly consisting of red, green and blue three original colored LEDS enclosed in a globe whose inner wall surface is spray coated with a layer of fluorescent powder such that emitted light from the LED assembly by operating a control circuit is blended into various desired resultant colored lights and outputted through all directional refraction of the globe.

2. Description of the Prior Art

There are a lot of electric light sources, for example, incandescent lamps, fluorescent lamps, halogen lamps, and arc discharge lamps etc., all can be used for illuminating the surrounding for the convenience of human being.

An incandescent lamp depends on its tungsten filament operating at a high temperature to radiate light. However, incandescent lamps are known to be disadvantageous for low lighting efficacy only a small percentage of total radiation is in the visible region with high power consumption, frequent replacement needed owing to their short lifetime, all these factors sum up to restrict their practicability.

Fluorescent lamps are welcome for their high intensity luminous output in which light is produced predominantly by fluorescent powders activated by ultraviolet energy generated by a mercury arc. However, fluorescent laps are not releasable from annoyment of stroboscopic effect and flicker which results in eye fatigue when AC power is used. Besides, people penalize fluorescent lamps for using harmful ultraviolet ray to activate flurescent powder for obtaining visible radiation.

Halogen lamps and various arc discharge lamps have their special outstanding features, but their common disadvantages are high market price and high power consumption.

In the meanwhile, the aforementioned light sources are unexceptionally only able to provide a fixed color light but is not able to vary its color even by operation of some menas.

Rapid development of modern electronic technology has brought us a new light source LED. FIG. 5 is a schematic view of a LED 8 by which the light is emitted within a definite angle and region. No matter how many unit LEDS 8 are combined in a LED assembly, uneven light distribution and possibly unlighted dead angle region are inevitable but vainly increasing an installation cost, besides, a uniform blend of color is not obtainable by two LEDS of different colors. FIG. 6 is a schematic view of another type of LED 9 in which a rear reflection plate 91 is employed so as to form a light source with an enlarged light emitting area, but it weakens intensity of light and is unpracticable.

In order to overcome the shortcomings inherent to the conventional technique described above, the present inventor has delved into this matter with long time efforts and came to realization of the present invention.

### SUMMARY OF THE INVENTION

Consequently, it is an object of the present invention to provide a LED assembly composed of red, green and blue primary color unt LEDS capable of emitting three primary colored light s in different ratio by operating a control circuit and activating a fluorescent power layer for color blend.

It is another object of the present invention to provide a LED assembly composed of red, green and blue primary color unit LEDS to be installed in a semi-spherical, or a tubular or a flat plate, or any other shaped globe for refracting the resultant colored light uniformly to all direction for environment lighting, and the resultant colored light can be dimmed.

For achieving these and other objects mentioned above, the present invention provides a high intensity light source enclosed in a transparent plastic globe whose inner wall surface is spray coated to form a fluorescent powder layer for color blending, a LED assembly composed of red, green, and blue primary color unit LEDS is installed therein, the light is emitted form the LEDS containing different ratio of three colors by operating a control circuit thus various desired resultant colored lights can be produced depending on the blending effect of the fluorescent powder, and the resultant colored lights are refracted uniformly to all direction for environment lighting.

In the present invention, the blended resultant colored lights can be dimmed in accordance with dimming of corresponding light emitted from the LED assembly.

In the present invention, the contour of the globe for LED assembly can be formed into a semi-spherical, or a tubular, or a flat plate, or any other geometrical shape.

### BRIEF DESCRIPTION OF THE DRAWINGS

The above and other objects, advantages and features of the present invention will become more readily appreciated and understood from a consideration of the following detailed description of preferred embodiments of the present invention when taken together with the accompanying drawings in which:

FIG. 1 is a schematic view of a high intensity light source capable of emitting various colored lights according to the present invention;

FIG. 2 is a schematic view of a high intensity light source in a first embodiment of the present invention;

FIG. 3 is a schematic view of a high intensity light source in a second embodiment of the present invention;

FIG. 4 is a schematic view of a high intensity light source in a third embodiment of the present invention;

FIG. 5 is a schematic view of a LED; and

FIG. 6 is a schematic view of another type of LED.

### DETAILED DESCRIPTION OF THE PREFERRED EMBODIMENT

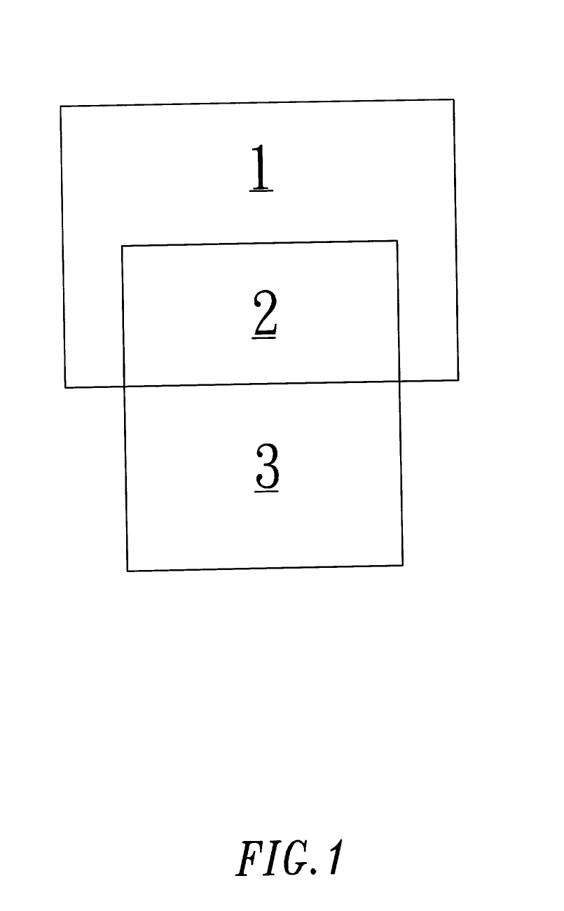

FIG. 1 shows a schematic view of a high intensity light source of the present invention. As shown in the drawing, the inner wall surface of a transparent plastic globe 5 (not shown) is spray coated to form a fluorescent powder layer 1 for color blending, a LED assembly 2 composed of red, green, and blue primary color unit LEDS is installed in the globe 5, and the light emitted therefrom is operated by a control circuit 3 for different color ratio so that various desired resultant colored lights can be obtained depending on the blending effect of the fluorescent power, and the resultant light is further refracted uniformly by the globe Sto all direction. Besides, the blended resultant color light can be dimmed in accordance with dimming of corresponding light emitted from the LED assembly 2 by means of operating the control circuit 3.

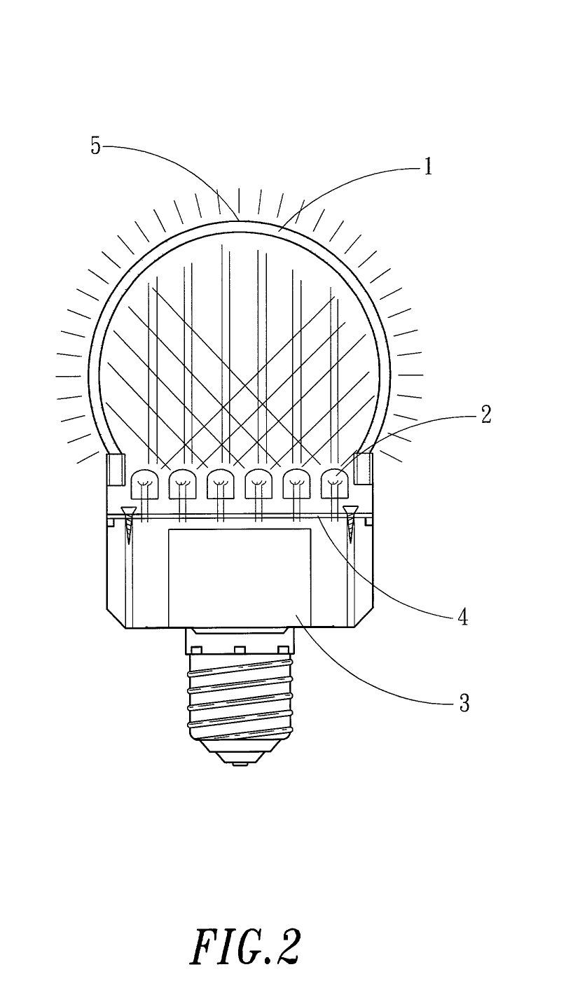

FIG. 2 shows a schematic view of a high intensity light source in a first embodiment of the present invention. As shown in FIG. 2, the contour of the globe 5 is formed into a semi-spherical shape with its inner wall thereof spray coated with a layer of fluorescent powder 1 so as to blend the lights containing red, green, and blue primary color components in different ratio into various resultant colored light. The LED assembly 2 as a light source, is connected to an electric circuit board 4 which is further connected to the control circuit 3 for controlling the components of three color light emitted from the LED assembly 2. The resultant colored light blended by the fluorescent powder layer 1 is outputted uniform from the semi-spherical globe 5 through all directional refraction.

In this version, various colored lights are obtainable from a single LED assembly by only varying the ratio of red, green, and blue original colored lights emitted from this LED assembly.

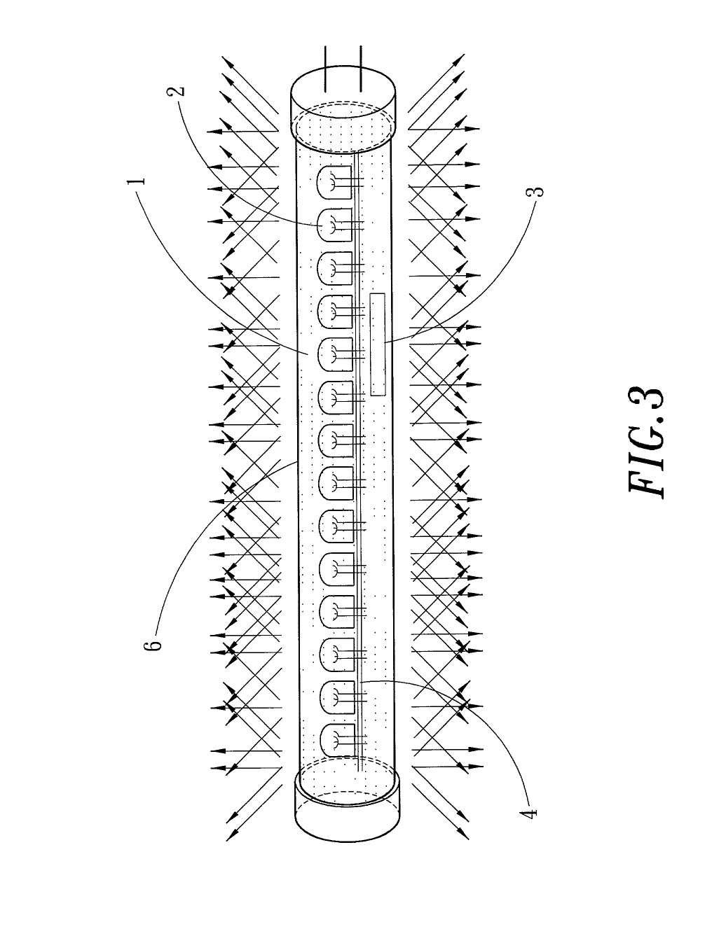

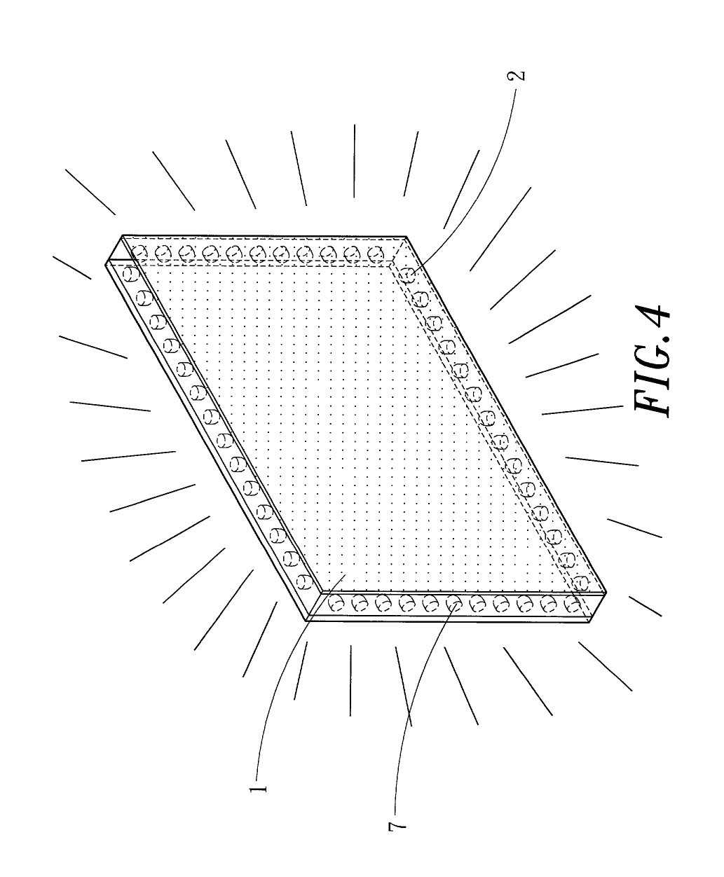

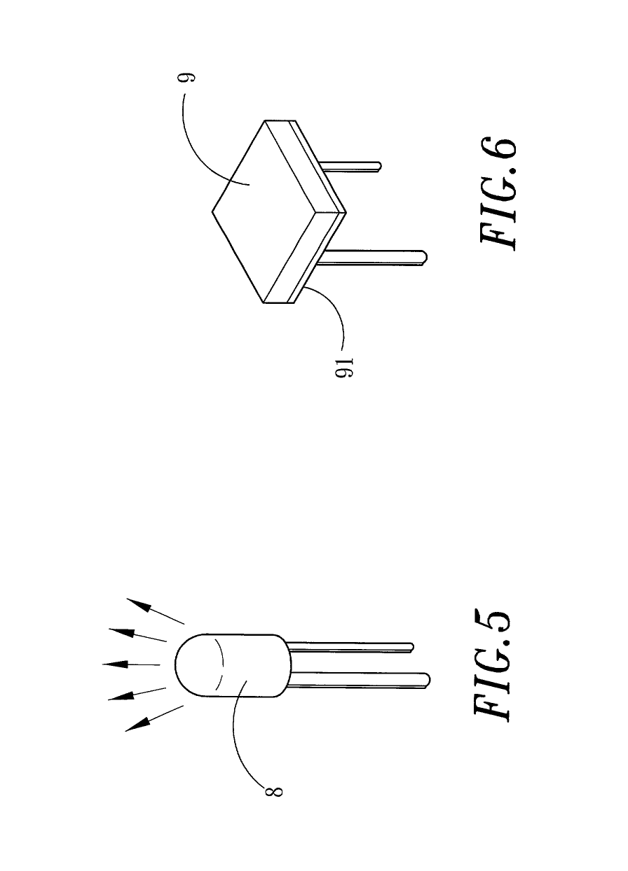

FIG. 3 and FIG. 4 show respectively the schematic views of a high intensity light source in a second and a third embodiments of the present invention, wherein contour of the globe 6 is formed into a tubular shape like a fluorescent lamp(see FIG. 3), or contour of the globe 7 is formed into a flat plate shape (see FIG. 4). Of course, contour of the globe may be formed into any other favorite geometrical shapes of customers.

It emerges from the description of the above embodiments that the invention has several noteworthy advantages, in particular:

1.It can achieve lighting efficacy as high as above 7001 m/1.5W which is greater than that of the most progressive florescent lamp, and is free from annoying flicker as that is always experienced by the conventional fluorescent lamps since a DC power source is employed to drive LED instead of an AC source.

2.Theraml resistivity of the globe is below 130° C. /W which enables the globe to maintain its average temperature below 40° C.

3.A stable light wave spectrum can be obtained with brilliant color tint, the output colors are variable in 256 octaves which is suitable for interior decoration.

4.It is characterized by extremely long lifetime of 100,000 hr. and above, which is far longer than the light source of longest lifetime existing in the present day.

5.It is the most economical and best energy saving lighting equipment.

6.Main and peripheral materials used to construct this light source are all non-poisonous but wholesome, and ⅔ of them is recyclable for environment protection.

7.It is turned on with a low DC voltage to ensure electric safety, and is released from annoying stroboscopic and flicker disturbance which might be harmful to eyes, also there is no existence of threatening ultraviolet ray. Meanwhile, the globe is made of non-fragile transparent plastic.

If the product of the present invention is compared with that of any conventional technique, the remarkable advantages are:

1.Combined operation between the control circuit and the fluorescent powder layer is able to produce various colored lights free for customers selection.

2.Uniform all directional colored lights can be obtained from a simply constructed lighting equipment.

3.No gas is filled in the globe so that maintenance of the light source of the present invention is easier than any of the conventional light cources.

Only several preferred embodiments of the present invention and but a few examples of its versatility are shown and described in the present disclosure. It is to be understood that the present invention is capable of use in various other combination and environments and is capable of changes or modifications within the scope of inventive concept as expressed herein.

What is claimed is:

1. A high intensity light source capable of emitting various colored light being enclosed in a transparent plastic globe whose inner wall surface is spray coated to form a fluorescent powder layer for color blending, a LED assembly composed of red, green, and blue primary color unit LEDS being installed in said globe for serving as said light source, and regulating the ratio of said primary color lights emitted from said LED assembly by operating an associated control circuit such that various desired resultant colored lights can be produced depending on the blending effect of said fluorescent powder layer, and said resultant colored lights being refracted uniformly to all direction through said globe.

2. The light source of claim 1, wherein said blended resultant colored lights can be dimmed in accordance with dimming of corresponding light emitted from said LED assembly.

3. The light source of claim 1, wherein the contour of said globe for said LED assembly is formed into a semi-spherical shape.

4. The light source of claim 1, wherein the contour of said globe for said LED assembly is formed into a tubular fluorescent lamp shape.

5. The light source of claim 1, wherein the contour of said globe for said LED assembly is formed into a flat plate shape.

6. The light source of claim 1, wherein the contour of said globe for said LED assembly is formed into any geometrical shape.
